(19) United States
(12) Patent Application Publication
(10) Pub. No.: US 2018/0200643 A1
(43) Pub. Date: Jul. 19, 2018

(54) COMPACT WASTEWATER CONCENTRATOR UTILIZING A LOW TEMPERATURE THERMAL ENERGY SOURCE

(71) Applicant: HEARTLAND TECHNOLOGY PARTNERS LLC, St. Louis, MO (US)

(72) Inventors: Bernard F. Duesel, JR., Goshen, NY (US); Craig Clerkin, Stoughton, WI (US); Michael J. Rutsch, Pittsburgh, PA (US)

(21) Appl. No.: 15/744,527

(22) PCT Filed: Jul. 14, 2016
(86) PCT No.: PCT/US16/42360

§ 371 Date: Jan. 12, 2018

Related U.S. Application Data
(60) Provisional application No. 62/192,323, filed on Jul. 14, 2015.

(51) Int. Cl. B01D 1/14; B01D 1/30; B01D 1/00; B01D 1/16; C02F 1/12; C02F 1/16

(52) U.S. Cl. CPC B01D 1/14; B01D 1/305; C02F 1/16; B01D 1/16; C02F 1/12; B01D 1/0058

(57) ABSTRACT

A compact and portable liquid concentrator includes a gas inlet, a gas exit and a flow corridor connecting the gas inlet and the gas exit, wherein the flow corridor includes a narrowed portion that accelerates the gas through the flow corridor. A liquid inlet injects liquid into the gas stream at a point prior to the narrowed portion so that the gas-liquid mixture is thoroughly mixed within the flow corridor, causing a portion of the liquid to be evaporated. A demister or fluid scrubber downstream of the narrowed portion removes entrained liquid droplets from the gas stream and re-circulates the removed liquid to the liquid inlet through a re-circulating circuit. A source of low energy gas, such as low pressure steam from a power plant, is connected to the liquid to be concentrated to heat the liquid to be concentrated before or during the concentration process.

### FIELD OF THE DISCLOSURE

This application relates generally to liquid concentrators, and more specifically to compact, portable, inexpensive wastewater concentrators that can be easily connected to and use sources of low temperature energy, such as low pressure steam from a power plant or jacket water from internal combustion engines.

### BACKGROUND

Concentration of volatile substances can be an effective form of treatment or pretreatment for a broad variety of wastewater streams and may be carried out within various types of commercial processing systems. At high levels of concentration, many wastewater streams may be reduced to residual material in the form of slurries containing high levels of dissolved and suspended solids. Such concentrated residual may be readily solidified by conventional techniques for disposal within landfills or, as applicable, delivered to downstream processes for further treatment prior to final disposal. Concentrating wastewater can greatly reduce freight costs and required storage capacity and may be beneficial in downstream processes where materials are recovered from the wastewater.

An important measure of the effectiveness of a wastewater concentration process is the volume of residual produced in proportion to the volume of wastewater entering the process. In particular, low ratios of residual volume to feed volume (high levels of concentration) are the most desirable. Where the wastewater contains dissolved and/or suspended non-volatile matter, the volume reduction that may be achieved in a particular concentration process that relies on evaporation of volatiles is, to a great extent, limited by the method chosen to transfer heat to the process fluid.

Conventional processes that affect concentration by evaporation of water and other volatile substances may be classified as direct or indirect heat transfer systems depending upon the method employed to transfer heat to the liquid undergoing concentration (the process fluid). Indirect heat transfer devices generally include jacketed vessels that contain the process fluid, or plate, bayonet tube, coil type, shell, and tube type heat exchangers that are immersed within the process fluid. Mediums such as steam or hot oil are passed through the jackets or heat exchangers in order to transfer the heat required for evaporation. Direct heat transfer devices implement processes where the heating medium is brought into direct contact with the process fluid, which occurs in, for example, submerged combustion gas systems.

Generally speaking, a source of heat is required to perform concentration within evaporative processes. Numerous systems have been developed to use heat generated by various sources, such as heat generated in an engine, in a combustion chamber, in a gas compression process, etc., as a source of heat for wastewater processing. One example of such a system is disclosed in U.S. Pat. No. 7,214,290 in which heat is generated by combusting landfill gas within a submerged combustion gas evaporator, which is used to process leachate at a landfill site. U.S. Pat. No. 7,416,172 discloses a submerged gas evaporator in which waste heat may be provided to an input of the gas evaporator to be used in concentrating or evaporating liquids. While waste heat is generally considered to be a cheap source of thermal energy, to be used effectively in a wastewater processing operation, the waste heat must in many cases be transported a significant distance from the source of the waste heat to a location at which the evaporative or concentration process is to be performed. For example, in many cases, a landfill operation will have electricity generators which use one or more internal combustion engines operating with landfill gas as a combustion fuel. The exhaust of these generators or engines, which is typically piped through a muffler and an exhaust stack to the atmosphere at the top of a building containing the electrical generators, is a source of waste heat. However, to collect and use this waste heat, significant amounts of expensive piping and ductwork must be coupled to the exhaust stack to transfer the waste heat to location of the processing system, which will usually be at ground level away from the building containing the generators.

Some evaporative concentration devices use high temperature gases, such as exhaust from a landfill flare or exhaust from an engine, to heat and evaporate water from the wastewater stream. In some cases, supplies of high temperature gases may be limited or non-existent. In these cases, evaporative concentration of wastewater streams may be difficult.

### SUMMARY

A compact liquid concentrator that uses low temperature, high enthalpy (latent heat) gas streams form a thermal energy source, such as low pressure steam from power plants, includes a gas inlet, a gas outlet, a mixing corridor disposed between the gas inlet and the gas outlet, the mixing corridor forming a tortuous path that induces high turbulence within the flowing gas stream traveling from the gas inlet to the gas outlet, and a liquid inlet through which liquid to be concentrated is injected into the mixing corridor, the liquid inlet disposed in the mixing corridor between the gas inlet and the outlet of the mixing corridor. A demister is disposed downstream of the concentrator section, the demister acting as a liquid collector to remove entrained liquid droplets from gas flowing in the demister gas flow passage. A reservoir collects the liquid removed from the gas flowing in the demister. The collected liquid is circulated through an indirect heat exchanger, for example a heat exchanger that condenses low temperature steam from a power plant, that releases small quantities of sensible heat, and relatively large quantities of latent heat to the collected liquid. The low temperature gas heats the collected liquid sufficiently to accelerate evaporation of the collected liquid as it is recycled through the mixing corridor for further concentration. As a result, the compact liquid concentrator does not need a high temperature gas input and may use ambient air to circulate through the mixing corridor.

In another embodiment, the compact liquid concentrator using low temperature gas may be used as a first stage evaporator in a two-stage evaporation system. Two concentrators may be fluidly attached in series, the first concentrator may use low temperature gas to perform a first stage evaporation and the second concentrator may use high temperature gas to perform a second stage evaporation. By evaporating in two stages, the two-stage evaporation system reduces its need for high temperature gas. As a result, the second concentrator may be reduced in size relative to a single stage high temperature gas concentrator that would be needed to perform the same level of evaporation.

### BRIEF DESCRIPTION OF THE DRAWINGS

FIG. 1 is a general schematic diagram of a compact liquid concentrator that uses high temperature gas to perform evaporation of a portion of a liquid component of a wastewater stream;

FIG. 2 is a perspective view of a compact liquid concentrator which implements the concentration process of FIG. 1, connected to a source of high temperature gas in the form of exhaust gas produced by a flare;

FIG. 3 is a front perspective view of an evaporator/concentrator portion of the compact liquid concentrator of FIG. 2;

FIG. 4 is a schematic diagram of a control system which may be used in the compact liquid concentrator of FIG. 2 to control the operation of the various component parts of the compact liquid concentrator;

FIG. 5 is a schematic diagram of a two-stage liquid concentration system including the compact liquid concentrator of FIG. 2 and a low temperature gas compact liquid concentrator;

FIG. 6 is a perspective view of the low temperature gas compact liquid concentrator of FIG. 5; and

FIG. 7 is a schematic diagram of another embodiment of a two-stage liquid concentration system including the liquid concentrator of FIG. 1, and a low temperature gas compact liquid concentrator.

### DETAILED DESCRIPTION

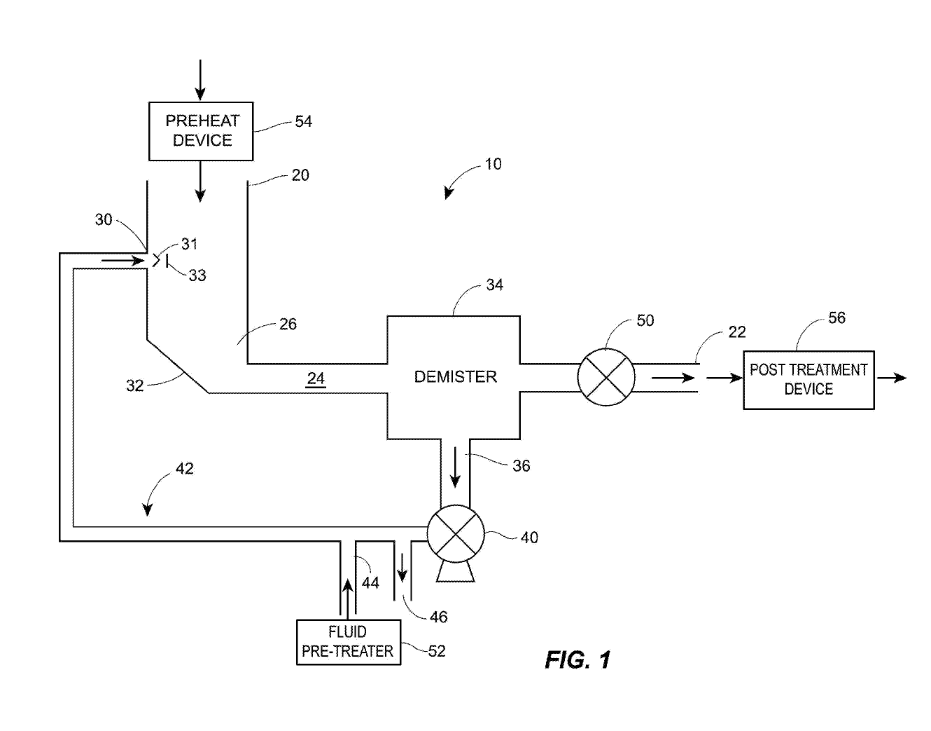

FIG. 1 illustrates a generalized schematic diagram of a liquid concentrator 10 that uses high temperature gas for evaporation, the liquid concentrator 10 includes a gas inlet 20, a gas exit 22 and a flow corridor 24 connecting the gas inlet 20 to the gas exit 22. The flow corridor 24 includes a tortuous path 26 that induces turbulence within the flow of gas through the flow corridor 24. The tortuous path 26 in this embodiment may be formed by a venturi device. A liquid inlet 30 injects a liquid to be concentrated (via evaporation) into a liquid concentration chamber in the flow corridor 24 at a point upstream of the tortuous path 26, and the injected liquid joins with the gas flow in the flow corridor 24. The liquid inlet 30 may include one or more replaceable nozzles 31 for spraying the liquid into the flow corridor 24. The inlet 30, whether or not equipped with any nozzle 31, may introduce the liquid in any direction from perpendicular to parallel to the gas flow as the gas moves through the flow corridor 24. A baffle 33 may also be located near the liquid inlet 30 such that liquid introduced from the liquid inlet 30 impinges on the baffle and disperses into the flow corridor in small droplets.

As the gas and liquid flow through the tortuous path 26, the venturi principle creates an accelerated and turbulent flow that thoroughly mixes the gas and liquid in the flow corridor 24 at and after the location of the inlet 30. As a result of the turbulent mixing, a portion of the liquid rapidly vaporizes and becomes part of the gas stream. As the gas-liquid mixture moves through the tortuous path 26, the direction and/or velocity of the gas/liquid mixture may be changed by an adjustable flow restriction, such as a venturi plate 32, which is generally used to create a large pressure difference in the flow corridor 24 upstream and downstream of the venturi plate 32. The venturi plate 32 may be adjustable to control the size and/or shape of the tortuous path 26 and may be manufactured from a corrosion resistant material including a high alloy metal such as those manufactured under the trade names of Hastelloy®, Inconel® and Monel®.

After leaving the tortuous path 26, the gas-liquid mixture passes through a demister 34 (also referred to as a fluid scrubber) coupled to the gas exit 22. The demister 34 removes entrained liquid droplets from the gas stream. The demister 34 includes a gas-flow passage. The removed liquid collects in a liquid collector or sump 36 in the gas-flow passage, the sump 36 may also include a reservoir for holding the removed liquid. A pump 40 fluidly coupled to the sump 40 and/or reservoir moves the liquid through a re-circulating circuit 42 back to the liquid inlet 30 and/or flow corridor 24. In this manner, the liquid may be reduced through evaporation to a desired concentration. Fresh or new liquid to be concentrated is input to the re-circulating circuit 42 through a liquid inlet 44. This new liquid may instead be injected directly into the flow corridor 24 upstream of the venturi plate 32. The rate of fresh liquid input into the re-circulating circuit 42 may be equal to the rate of evaporation of the liquid as the gas-liquid mixture flows through the flow corridor 24 plus the rate of liquid extracted through a concentrated fluid extraction port 46 located in or near the reservoir in the sump 40. The ratio of re-circulated liquid to fresh liquid may generally be in the range of approximately 1:1 to approximately 100:1, and is usually in the range of approximately 5:1 to approximately 25:1. For example, if the re-circulating circuit 42 circulates fluid at approximately 10 gal/min, fresh or new liquid may be introduced at a rate of approximately 1 gal/min (i.e., a 10:1 ratio). A portion of the liquid may be drawn off through the extraction port 46 when the liquid in the re-circulating circuit 42 reaches a desired concentration.

After passing through the demister 34 the gas stream passes through an induction fan 50 that draws the gas through the flow corridor 24 and demister gas-flow corridor under negative pressure. Alternatively, the concentrator 10 could operate under positive pressure produced by a blower (not shown) prior to the liquid inlet 30. Finally, the gas is vented to the atmosphere or directed for further processing through the gas exit 22.

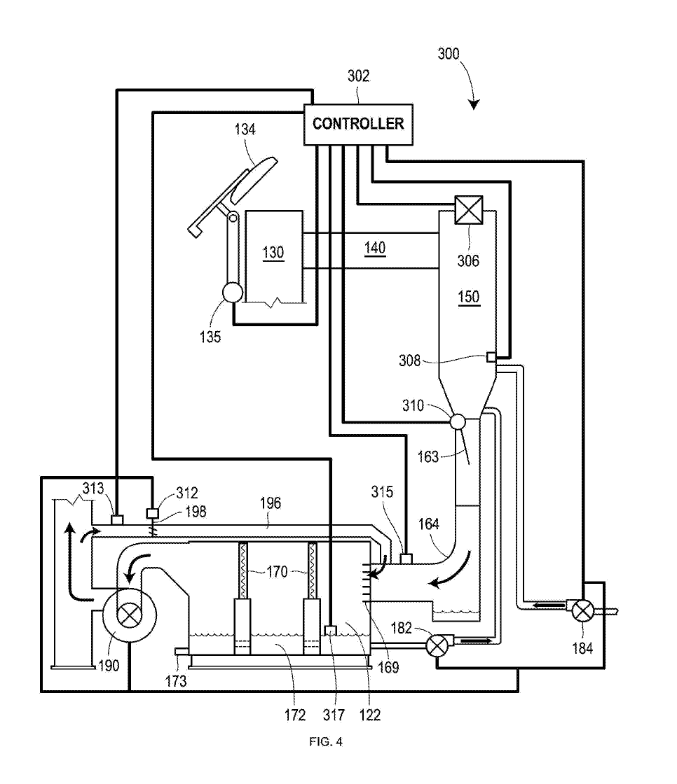

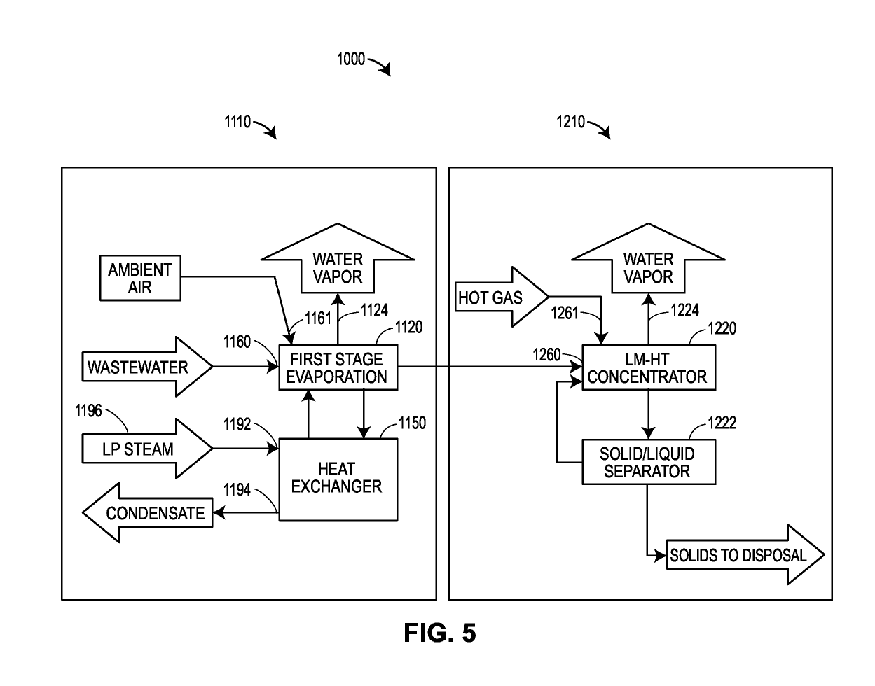

The concentrator 10 may include an optional liquid pre-treatment system 52 for treating the liquid to be concentrated, which may be a wastewater feed, such as a flue gas desulfurization wastewater feed from a power plant. For example, an air stripper may be used as a pre-treatment system 52 to remove substances that may produce foul odors or be regulated as air pollutants. In this case, the air stripper may be any conventional type of air stripper or may be a further concentrator of the type described herein, which may be used in series as the air stripper. The pre-treatment system 52 may, if desired, heat the liquid to be concentrated using any desired heating technique. For example, the pre-treatment system 52 may include a heat exchanger, such as a plate and frame heat exchanger or a shell and tube heat exchanger, that is powered by a low temperature gas or liquid stream, such as low pressure steam from a power plant or a recirculating heat transfer fluid device. The heat exchanger will be discussed further with respect to FIGS. 4 and 5. Additionally, the gas circulating through the concentrator 10 may be pre-heated in a pre-heater 54. Pre-heating may be used to enhance the rate of evaporation and thus the rate of concentration of the liquid. Also, waste heat from an engine, such as an internal combustion engine, may be used to pre-heat the gas and/or wastewater feed. Additionally, the gas streams ejected from the gas exit 22 of the concentrator 10 may be transferred into a flare, an electrostatic precipitator, or other post treatment device 56 which treats the gas before releasing the gas to the atmosphere.

The liquid concentrator 10 described herein may be used to concentrate a wide variety of wastewater streams, such as waste water from industry (e.g., flue gas desulfurization water in a power plant or produced water from gas or oil wells). The liquid concentrator 10 is practical, energy efficient, reliable, and cost-effective. In order to increase the utility of this liquid concentrator, the liquid concentrator 10 is readily adaptable to being mounted on a trailer or a moveable skid to effectively deal with wastewater streams in remote or difficult to reach areas. The liquid concentrator 10 described herein has all of these desirable characteristics and provides significant advantages over conventional wastewater concentrators, especially when the goal is to manage a broad variety of wastewater streams.

Moreover, the concentrator 10 may be largely fabricated from highly corrosion resistant, yet low cost materials such as fiberglass and/or other engineered plastics. This is due, in part, to the fact that the disclosed concentrator is designed to operate under minimal differential pressure and relatively mild temperatures. For example, a differential pressure generally in the range of only 10 to 30 inches water column and operating temperatures below 300° F. are all that are required. Also, because the gas-liquid contact zones of the concentration processes generate high turbulence causing rapid evaporation and resultant rapid cooling of the liquid being evaporated within a compact mixing corridor, the overall design is very compact as compared to conventional concentrators where the gas liquid contact occurs in large process vessels with significantly larger high temperature zones. As a result, the amount of high alloy metals required to withstand corrosive forces at elevated temperatures for the concentrator 10 is quite minimal. Also, because these high alloy parts are small and can be readily replaced in a short period of time with minimal labor, fabrication costs may be cut to an even higher degree by designing some or all of these parts to be fabricated either entirely from low-cost engineered materials, such as fiberglass and CPVC, or from lesser quality metals and alloys coated with corrosion and/or erosion resistant liners, such as engineered plastics including elastomeric polymers, to extend the useful life of such components. Likewise, the pump 40 may be provided with corrosion and/or erosion resistant liners to extend the life of the pump 40, thus further reducing maintenance and replacement costs.

The liquid concentrator 10 provides direct contact of the liquid to be concentrated and the gas, effecting highly turbulent and rapid heat exchange and mass transfer between gas and the liquid, e.g., wastewater, undergoing concentration. Moreover, the concentrator 10 employs highly compact gas-liquid contact zones, making it minimal in size as compared to known concentrators. The direct contact heat exchange feature promotes high energy efficiency and eliminates the need for solid surface heat exchangers as used in conventional, indirect heat transfer concentrators. Further, the compact gas-liquid contact zone eliminates the bulky process vessels used in both conventional indirect and direct heat exchange concentrators. These features allow the concentrator 10 to be manufactured using comparatively low cost fabrication techniques and with reduced weight as compared to conventional concentrators. Both of these factors favor portability and cost-effectiveness. Thus, the liquid concentrator 10 is more compact and lighter in weight than conventional concentrators, which make it ideal for use as a portable unit. Additionally, the liquid concentrator 10 is less prone to fouling and blockages due to the direct contact heat exchange operation and the lack of solid heat exchanger surfaces. The liquid concentrator 10 can also process liquids with significant amounts of suspended solids because of the direct contact heat exchange. As a result, high levels of concentration of the process fluids may be achieved without need for frequent cleaning of the concentrator 10.

More specifically, in liquid concentrators that employ indirect heat transfer, the heat exchangers are prone to fouling and are subject to accelerated effects of corrosion at the normal operating temperatures of the hot heat transfer medium that is circulated within them (steam or other hot fluid). Each of these factors places significant limits on the durability and/or costs of building conventional indirectly heated concentrators, and on how long they may be operated before it is necessary to shut down and clean or repair the heat exchangers. By eliminating the bulky process vessels, the weight of the liquid concentrators and both the initial costs and the replacement costs for high alloy components are greatly reduced. Moreover, due to the temperature difference between the gas and liquid, the relatively small volume of liquid contained within the system, and the reduced relative humidity of the gas prior to mixing with the liquid, the concentrator 10 operates at close to the adiabatic saturation temperature for the particular gas/liquid mixture, which is typically in the range of about 130 degrees Fahrenheit to about 195 degrees Fahrenheit. Further, as an adiabatic evaporation process with no heat being driven into the process through heat exchange surfaces or walls of the process equipment, the gas flowing through the system rapidly approaches saturation, which eliminates a driving force for further evaporation and the potential for concentrated liquid undergoing processing to dry upon, and create buildup on, solid surfaces within the concentrator. This factor reduces the required cleaning frequency while greatly simplifying procedures for periodic cleaning of the concentrator equipment.

Moreover, the concentrator 10 is designed to operate under negative pressure, a feature that greatly enhances the ability to use a very broad range of fuel or waste heat sources as an energy source to affect evaporation. In fact, due to the draft nature of these systems, pressurized or non-pressurized burners may be used to heat and supply the gas used in the concentrator 10. Further, the simplicity and reliability of the concentrator 10 is enhanced by the minimal number of moving parts and wear parts that are required. In general, only two pumps and a single induced draft fan are required for the concentrator when it is configured to operate on waste heat such as stack gases from engines (e.g., generators or vehicle engines), industrial process stacks, gas compressor systems, and flares, such as landfill gas flares. These features provide significant advantages that reflect favorably on the versatility and the costs of buying, operating and maintaining the concentrator 10.

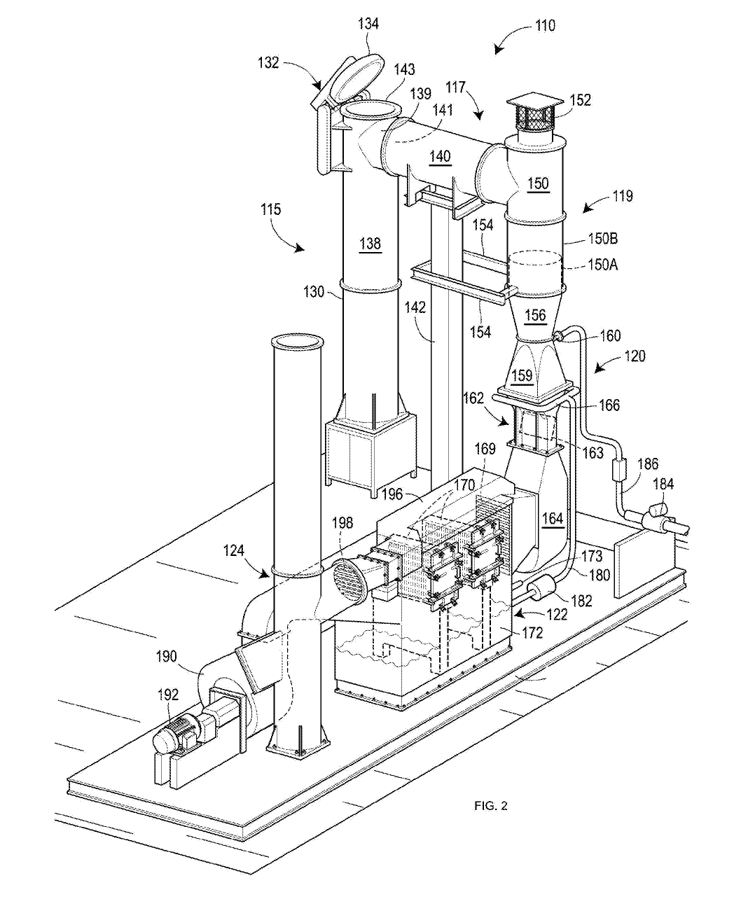

FIG. 2 illustrates one particular embodiment of a compact liquid concentrator 110 which operates using the principles described above with respect to FIG. 1 and which is connected to a source of waste heat in the form of a flare. Generally speaking, the compact liquid concentrator 110 of FIG. 2 operates to concentrate wastewater, using exhaust or waste heat created within a flare. Typically, the gas exiting the flare is greater than 1000 degrees Fahrenheit and generally between 1500 degrees Fahrenheit and 1800 degrees Fahrenheit. While not illustrated in FIG. 2, virtually any other source of hot gas may be substituted for the flare gas. For example, heat from an exhaust gas from an internal combustion engine or a turbine may be used instead of combustion exhaust gas from a flare.

As illustrated in FIG. 2, the compact liquid concentrator 110 generally includes or is connected to a flare assembly 115, and includes a heat transfer assembly 117, an air pre-treatment assembly 119, a concentrator assembly 120, a fluid scrubber 122, and an exhaust section 124. The flare assembly 115 includes a flare 130, and may include an optional flare cap assembly 132. The flare cap assembly 132 includes a moveable cap 134 (e.g., a flare cap, an exhaust gas cap, etc.) which covers the top of the flare 130, or other type of stack (e.g., a combustion gas exhaust stack), to seal off the top of the flare 130 when the flare cap 134 is in the closed position, or to divert a portion of the flare gas in a partially closed position, and which allows gas produced within the flare 130 to escape to the atmosphere through an open end that forms a primary gas outlet 143, when the flare cap 134 is in an open or partially open position. The flare cap assembly 132 also includes a cap actuator, such as a motor (e.g., an electric motor, a hydraulic motor, a pneumatic motor, etc.) which moves the flare cap 134 between the fully open and the fully closed positions. The flare cap actuator may, for example, rotate or move the flare cap 134 around a pivot point to open and close the flare cap 134. The flare cap actuator may utilize a chain drive or any other type of drive mechanism connected to the flare cap 134 to move the flare cap 134 around the pivot point 136. The flare cap assembly 132 may also include a counter-weight disposed on the opposite side of a pivot point from the flare cap 134 to balance or offset a portion of the weight of the flare cap 134 when moving the flare cap 134 around the pivot point. The counter-weight enables the actuator to be reduced in size or power while still being capable of moving or rotating the flare cap 134 between an open position, in which the top of the flare 130 (or the primary combustion gas outlet 143) is open to the atmosphere, and a closed position, in which the flare cap 134 covers and essentially seals the top of the flare 130 (or the primary combustion gas outlet 143). The flare cap 134 itself may be made of high temperature resistant material, such as stainless steel or carbon steel, and may be lined or insulated with refractory material including aluminum oxide and/or zirconium oxide on the bottom portion thereof which comes into direct contact with the hot flare gases when the flare cap 134 is in the closed position. In other embodiments, other flare cap configurations may be used, such as a sliding arrangement on rails in a horizontal plane, as opposed to pivoting, as illustrated in FIG. 2.

If desired, the flare 130 may include an adapter section 138 including the primary combustion gas outlet 143 and a secondary combustion gas outlet 141 downstream of the primary combustion gas outlet 143. When the flare cap 130 is in the closed position, combustion gas is diverted through the secondary combustion gas outlet 141. The adapter section 138 may include a connector section 139 that connects the flare 130 (or exhaust stack) to the heat transfer section 117 using a 90 degree elbow or turn. Other connector arrangements are possible. For example, the flare 130 and heat transfer section 117 may be connected at virtually any angle between 0 degrees and 180 degrees. In this case, the flare cap assembly 132 is mounted on the top of the adaptor section 138 proximate the primary combustion gas outlet 143.

As illustrated in FIG. 2, the heat transfer assembly 117 includes a transfer pipe 140, which connects to an inlet of the air pre-treatment assembly 119 to the flare 130 and, more particularly, to the adaptor section 138 of the flare 130. A support member 142, in the form of a vertical bar or pole, supports the heat transfer pipe 140 between the flare 130 and the air pre-treatment assembly 119 at a predetermined level or height above the ground. The heat transfer pipe 140 is connected to the connector section 139 or the adapter section 138 at the secondary combustion gas outlet 141, the transfer pipe forming a portion of a fluid passageway between the adapter section 138 and a secondary process, such as a fluid concentrating process. The support member 142 is typically necessary because the heat transfer pipe 140 will generally be made of metal, such as carbon or stainless steel, and may be refractory lined with materials such as aluminum oxide and/or zirconium oxide, to withstand the temperature of the gas being transferred from the flare 130 to the air pre-treatment assembly 119. Thus, the heat transfer pipe 140 will typically be a heavy piece of equipment. However, because the flare 130, on the one hand, and the air pre-treatment assembly 119 and the concentrator assembly 120, on the other hand, are disposed immediately adjacent to one another, the heat transfer pipe 140 generally only needs to be of a relatively short length, thereby reducing the cost of the materials used in the concentrator 110, as well as reducing the amount of support structure needed to bear the weight of the heavy parts of the concentrator 110 above the ground. As illustrated in FIG. 2, the heat transfer pipe 140 and the air pre-treatment assembly 119 form an upside-down U-shaped structure. In other embodiments, the concentrator 110 may be located a greater distance from the flare 130. In this case, the heat transfer pipe 140 may be lengthened to accommodate the distance.

The air pre-treatment assembly 119 includes a vertical piping section 150 and an ambient air valve (not shown explicitly in FIG. 2) disposed at the top of the vertical piping section 150. The ambient air valve (also referred to as a bleed valve) forms a fluid passageway between the heat transfer pipe 140 (or air pre-treatment assembly 119) and the atmosphere. The ambient air valve operates to allow ambient air to flow through a mesh bird screen 152 (typically wire or metal) and into the interior of the air pre-treatment assembly 119 to mix with the hot gas coming from the flare 130. If desired, the air pre-treatment assembly 119 may include a permanently open section proximate to the bleed valve which always allows some amount of bleed air into the air pre-treatment assembly 119, which may be desirable to reduce the size of the required bleed valve and for safety reasons. While the control of the ambient air or bleed valve will be discussed in greater detail hereinafter, this valve generally allows the gas from the flare 130 to be cooled to a more useable temperature before entering into the concentrator assembly 120. The air pre-treatment assembly 119 may be supported in part by cross-members 154 connected to the support member 142. The cross-members 154 stabilize the air pre-treatment assembly 119, which is also typically made of heavy carbon or stainless steel or other metal, and which may be refractory-lined to improve energy efficiency and to withstand the high temperature of the gases within this section of the concentrator 110. If desired, the vertical piping section 150 may be extendable to adapt to or account for flares of differing heights so as to make the liquid concentrator 110 easily adaptable to many different flares or to flares of different heights. As shown in FIG. 2, the vertical piping section 150 may include a first section 150A (shown using dotted lines) that rides inside of a second section 150B thereby allowing the vertical piping section 150 to be adjustable in length (height).

Generally speaking, the air pre-treatment assembly 119 operates to mix ambient air provided through the ambient air valve beneath the screen 152 and the hot gas flowing from the flare 130 through the heat transfer pipe 140 to create a desired temperature of gas at the inlet of the concentrator assembly 120.

The liquid concentrator assembly 120 includes a lead-in section 156 having a reduced cross-section at the bottom end thereof which mates the bottom of the piping section 150 to a quencher 159 of the concentrator assembly 120. The concentrator assembly 120 also includes a first fluid inlet 160, which injects new or untreated liquid to be concentrated, such as flue gas desulfurization water, into the interior of the quencher 159. While not shown in FIG. 2, the inlet 160 may include a coarse sprayer with a large nozzle for spraying the untreated liquid into the quencher 159. Because the liquid being sprayed into the quencher 159 at this point in the system is not yet concentrated, and thus has large amount of liquid to be evaporated therein, and because the sprayer is a coarse sprayer, the sprayer nozzle is not prone to fouling or being clogged by the small particles within the liquid. The quencher 159 operates to quickly reduce the temperature of the gas stream (e.g., from about 900 degrees Fahrenheit to less than 200-300 degrees Fahrenheit) while performing a high degree of evaporation on the liquid injected at the inlet 160 by both increasing the volume of the air in the quencher 159 and by performing some degree of evaporation. Thus configured, the quencher 159 serves to prevent complete evaporation of the volatile liquid at any location within the concentrator 110 by rapidly saturating the hot gas from the quencher 159 with vapor, thus eliminating any driving force for additional evaporation. Prevention of complete drying is an important feature to prevent deleterious buildup of solids on the interior walls of the concentrator 110. If desired, but not specifically shown in FIG. 2, a temperature sensor may be located at or near the exit of the piping section 150 or in the quencher 159 and may be used to control the position of the ambient air valve to thereby control the temperature of the gas present at the inlet of the concentrator assembly 120.

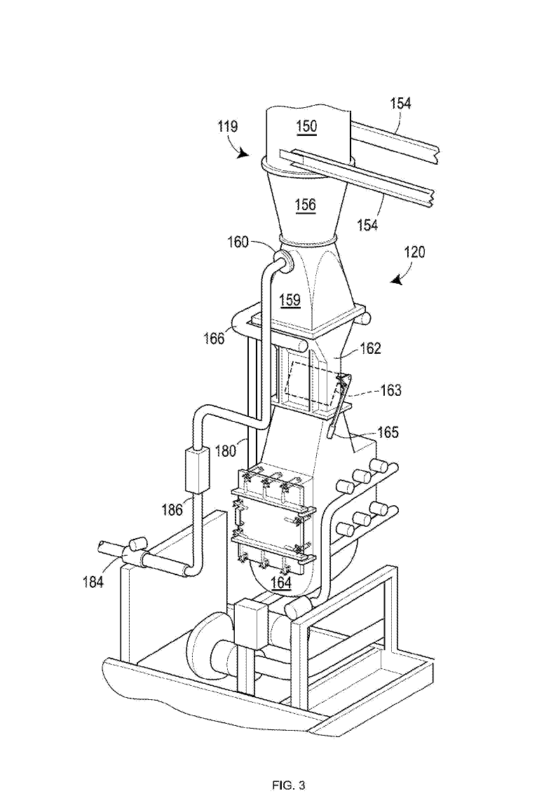

As shown in FIGS. 2 and 3, the quencher 159 is connected to liquid injection chamber which is connected to narrowed portion or venturi section 162 which has a narrowed cross section with respect to the quencher 159 and which has a venturi plate 163 (shown in dotted line) disposed therein. The venturi plate 163 creates a narrow passage through the venturi section 162, which creates a large pressure drop between the entrance and the exit of the venturi section 162. This large pressure drop causes turbulent gas flow within the quencher 159 and the top or entrance of the venturi section 162, and causes a high rate of gas flow out of the venturi section 162, both of which lead to breakdown of the volatile fluid to fine droplets, and dispersion of the fine droplets within the continuous gas phase, thereby creating extensive dynamic renewable surface area on the dispersed droplets along with thorough mixing of the gas and liquid in the venturi section 162. Creation of this surface area promotes very rapid heat and mass transfer between the continuous phase (hot gas) and the discontinuous phase (droplets of volatile fluid with dissolved and/or suspended solids) mixture. The position of the venturi plate 163 may be controlled with a manual control rod 165 (shown in FIG. 3) connected to the pivot point of the plate 163, or via an electric control mechanism, such as motor (not shown).

A re-circulating pipe 166 extends around opposite sides of the entrance of the venturi section 162 and operates to inject partially concentrated (i.e., re-circulated) liquid into the venturi section 162 to be further concentrated and/or to prevent the formation of dry particulate within the concentrator assembly 120 through multiple fluid entrances located on one or more sides of the flow corridor. While not explicitly shown in FIGS. 2 and 3, a number of pipes, such as three pipes of, for example, ½ inch diameter, may extend from each of the opposites legs of the pipe 166 partially surrounding the venturi section 162, and through the walls and into the interior of the venturi section 162. Because the liquid being ejected into the concentrator 110 at this point is re-circulated liquid, and is thus either partially concentrated or being maintained at a particular equilibrium concentration and more prone to plug a spray nozzle than the less concentrated liquid injected at the inlet 160, this liquid may be directly injected without a sprayer so as to prevent clogging. However, if desired, a baffle in the form of a flat plate may be disposed in front of each of the openings of the ½ inch diameter pipes in this example to cause the liquid being injected at this point in the system to hit the baffle and disperse into the concentrator assembly 120 as smaller droplets. In any event, the configuration of this re-circulating system distributes or disperses the re-circulating liquid better within the gas stream flowing through the concentrator assembly 120.

The combined hot gas and liquid flows in a turbulent manner through the venturi section 162. As noted above, the venturi section 162, which has a moveable venturi plate 163 disposed across the width of the concentrator assembly 120, causes turbulent flow and complete mixture of the liquid and gas, causing rapid evaporation of the dispersed liquid droplet phase into the continuous gas phase. Because the mixing action caused by the venturi section 162 provides a high rate of evaporation through continuous creation of dynamic renewable surface area, the gas cools substantially and rapidly in the concentrator assembly 120, and exits the venturi section 162 into a flooded elbow 164 at high velocity. In fact, the temperature of the gas-liquid mixture at this point approaches the adiabatic saturation temperature for the particular gas and volatile liquid mixture, which may be about 160 degrees Fahrenheit in some examples.

The bottom of the flooded elbow 164 has a pool of liquid disposed therein, and the gas-liquid mixture exiting the venturi section 162 at high rates of speed impinges on the pool of liquid, which is maintained at a fixed level by means of an overflow weir that forms a portion of the wall of the flooded elbow 164. The gas-liquid mixture is forced to turn 90 degrees to flow into the fluid scrubber 122 in this example. The interaction of the gas-liquid stream with the liquid within the flooded elbow 164 removes liquid droplets through impingement of the droplets upon the surface of the pool of liquid within the flooded elbow 164 and subsequent coalescence into the liquid. Further, the pool of liquid within the flooded elbow 164 prevents suspended particles within the gas-liquid stream from hitting the bottom of flooded elbow 164 at high rates of speeds, thereby preventing erosion of the metal wall of the flooded elbow 164.

After leaving the flooded elbow 164, the gas-liquid stream in which evaporated liquid and some liquid and other particles still exist, flows through the fluid scrubber 122 which is, in this case, a cross-flow fluid scrubber. The fluid scrubber 122 includes various screens or filters which aid in removal of entrained liquids from the gas-liquid stream and removes other particles that might be present with the gas-liquid stream. In one particular example, the cross flow scrubber 122 may include an initial coarse impingement baffle 169 at the input thereof, which is designed to remove liquid droplets in the range of 50 to 100 microns in size or higher. Thereafter, two removable filters in the form of chevrons 170 are disposed across the fluid path through the fluid scrubber 122, and the chevrons 170 may be progressively sized or configured to remove liquid droplets of smaller and smaller sizes, such as 20-30 microns and less than 10 microns. Of course, more or fewer filters or chevrons could be used.

Liquid captured by the filters 169 and 170 gravity drains into a reservoir or sump 172 located at the bottom of the fluid scrubber 122. The sump 172, which may hold, for example 200 gallons of liquid or more, thereby collects concentrated fluid containing dissolved and suspended solids removed from the gas-liquid stream and operates as a reservoir for a source of re-circulating concentrated liquid back to the concentrator assembly 120 to be further treated and/or to prevent the formation of dry particulate within the concentrator assembly 120 in the manner described above with respect to FIG. 1. In one embodiment, the sump 172 may include a sloped V-shaped bottom (not shown) having a V-shaped groove extending from the back of the fluid scrubber 122 (furthest away from the flooded elbow 164) to the front of the fluid scrubber 122 (closest to the flooded elbow 164), wherein the V-shaped groove is sloped such that the bottom of the V-shaped groove is lower at the end of the fluid scrubber 122 nearest the flooded elbow 164 than at an end farther away from the flooded elbow 164. In other words, the V-shaped bottom may be sloped with the lowest point of the V-shaped bottom proximate the exit port 173 and/or the pump 182. Additionally, a washing circuit (not shown) may pump concentrated fluid from the sump 172 to a sprayer (not shown) within the cross flow scrubber 122, the sprayer being aimed to spray liquid at the V-shaped bottom. Alternatively, the sprayer may spray unconcentrated liquid or clean water at the V-shaped bottom. The sprayer may periodically or constantly spray liquid onto the surface of the V-shaped bottom to wash solids and prevent solids buildup on the V-shaped bottom or at the exit port 173 and/or the pump 182. As a result of this V-shaped sloped bottom and pump, liquid collecting in the sump 172 is continuously agitated and renewed, thereby maintaining a relatively constant consistency and maintaining solids in suspension. If desired, the spraying circuit may be a separate circuit using a separate pump with, for example, an inlet inside of the sump 173, or may use a pump 182 associated with a concentrated liquid re-circulating circuit described below to spray concentrated fluid from the sump onto the V-shaped bottom of the sump 172.

As illustrated in FIG. 2, a return line 180, as well as a pump 182, operates to re-circulate fluid removed from the gas-liquid stream from the sump 172 back to the concentrator 120 and thereby complete a fluid or liquid re-circulating circuit. Likewise, a pump 184 may be provided within an input line 186 to pump new or untreated liquid, such as landfill leachate, to the input 160 of the concentrator assembly 120. Also, one or more sprayers may be disposed inside the fluid scrubber 122 adjacent the chevrons 170 and may be operated periodically to spray clean water or a portion of the wastewater feed on the chevrons 170 to keep them clean.

Concentrated liquid also be removed from the bottom of the fluid scrubber 122 via the exit port 173 and may be further processed or disposed of in any suitable manner in a secondary re-circulating circuit. In particular, the concentrated liquid removed by the exit port 173 contains a certain amount of suspended solids, which preferably may be separated from the liquid portion of the concentrated liquid and removed from the system using a secondary re-circulating circuit. For example, concentrated liquid removed from the exit port 173 may be transported through a secondary concentrated wastewater circuit (not shown) to a solid/liquid separating device, such as a settling tank, a vibrating screen, a rotary vacuum filter, or a filter press. After the suspended solids and liquid portion of the concentrated wastewater are separated by the solid/liquid separating device, the liquid portion of the concentrated wastewater may be returned to the sump 172 for further processing in the first or primary re-circulating circuit connected to the concentrator.

The gas, which flows through and out of the fluid scrubber 122 with the liquid and suspended solids removed therefrom, exits out of piping or ductwork at the back of the fluid scrubber 122 (downstream of the chevrons 170) and flows through an induced draft fan 190 of the exhaust assembly 124, from where it is exhausted to the atmosphere in the form of the cooled inlet gas mixed with the evaporated water vapor. Of course, an induced draft fan motor 192 is connected to and operates the fan 190 to create negative pressure within the fluid scrubber 122 so as to ultimately draw gas from the flare 130 through the transfer pipe 140, the air pre-treatment assembly 119 and the concentrator assembly 120. As described above with respect to FIG. 1, the induced draft fan 190 needs only to provide a slight negative pressure within the fluid scrubber 122 to assure proper operation of the concentrator 110.

The speed of the induced draft fan 190 can be varied by a device such as a variable frequency drive operated to create varying levels of negative pressure within the fluid scrubber 122 and thus can usually be operated within a range of gas flow capacity to assure complete gas flow from the flare 130, if the gas being produced by the flare 130 is not of sufficient quantity, the operation of the induced draft fan 190 cannot necessarily be adjusted to assure a proper pressure drop across the fluid scrubber 122 itself. That is, to operate efficiently and properly, the gas flowing through the fluid scrubber 122 must be at a sufficient (minimal) flow rate at the input of the fluid scrubber 122. Typically this requirement is controlled by keeping at least a preset minimal pressure drop across the fluid scrubber 122. However, if the flare 130 is not producing at least a minimal level of gas, increasing the speed of the induced draft fan 190 will not be able to create the required pressure drop across the fluid scrubber 122.

To compensate for this situation, the cross flow scrubber 122 may designed to include an optional gas re-circulating circuit which can be used to assure that enough gas is present at the input of the fluid scrubber 122 to enable the system to acquire the needed pressure drop across the fluid scrubber 122. In particular, the gas re-circulating circuit may include a gas return line or return duct 196 which connects the high pressure side of the exhaust assembly 124 (e.g., downstream of the induced draft fan 190) to the input of the fluid scrubber 122 (e.g., a gas input of the fluid scrubber 122) and a baffle or control mechanism 198 disposed in the return duct 196 which operates to open and close the return duct 196 to thereby fluidly connect the high pressure side of the exhaust assembly 124 to the input of the fluid scrubber 122. During operation, when the gas entering into the fluid scrubber 122 is not of sufficient quantity to obtain the minimal required pressure drop across the fluid scrubber 122, the baffle 198 (which may be, for example, a gas valve, a damper such as a louvered damper, etc.) is opened to direct gas from the high pressure side of the exhaust assembly 124 (i.e., gas that has traveled through the induced draft fan 190) back to the input of the fluid scrubber 122. This operation thereby provides a sufficient quantity of gas at the input of the fluid scrubber 122 to enable the operation of the induced draft fan 190 to acquire the minimal required pressure drop across the fluid scrubber 122.

The combination of features illustrated in FIGS. 1-3 makes for a compact fluid concentrator 110 that uses waste heat in the form of gas resulting from the operation of a landfill flare burning landfill gas, which waste heat would otherwise be vented directly to the atmosphere. Importantly, the concentrator 110 uses only a minimal amount of high temperature resistant (and thus expensive material) to provide the piping and structural equipment required to use the high temperature gases exiting from the flare 130. In particular, the small length of the transfer pipe 140, which is made of the most expensive materials, is minimized, thereby reducing the cost and weight of the fluid concentrator 110. Moreover, because of the small size of the heat transfer pipe 140, only a minimal amount of scaffolding, in the form of the support member 142, is needed thereby further reducing the costs of building the concentrator 110. Still further, the fact that the air pre-treatment assembly 119 is disposed directly on top of the fluid concentrator assembly 120, with the gas in these sections flowing downward towards the ground, enables these sections of the concentrator 110 to be supported directly by the ground or by a skid on which these members are mounted. Still further, this configuration keeps the concentrator 110 disposed very close to the flare 130, making it more compact. Likewise, this configuration keeps the high temperature sections of the concentrator 110 (e.g., the top of the flare 130, the heat transfer pipe 140 and the air pre-treatment assembly 119) above the ground and away from inadvertent human contact, leading to a safer configuration. In fact, due to the rapid cooling that takes place in the venturi section 162 of the concentrator assembly 120, the venturi section 162, the flooded elbow 164 and the fluid scrubber 122 are typically cool enough to touch without harm (even when the gases exiting the flare 130 are at 1800 degrees Fahrenheit). This fact also enables these components to be made of less expensive or lighter weight materials, such as carbon steel or fiberglass. In fact, in one embodiment, the fluid scrubber 122 is made of fiberglass, making it less expensive than higher alloys while maintaining exceptional corrosion resistance.

The fluid concentrator 110 is also a very fast-acting concentrator. Because the concentrator 110 is a direct contact type of concentrator, it is not subject to deposit buildup, clogging and fouling to the same extent as most other concentrators. Still further, the ability to control the flare cap 134 to open and close, depending on whether the concentrator 110 is being used or operated, allows the flare 130 to be used to burn gas without interruption when starting and stopping the concentrator 110. More particularly, the flare cap 134 can be quickly opened at any time to allow the flare 130 to simply burn gas as normal while the concentrator 110 is shut down. On the other hand, the flare cap 134 can be quickly closed when the concentrator 110 is started up, thereby diverting hot gasses created in the flare 130 to the concentrator 110, and allowing the concentrator 110 to operate without interrupting the operation of the flare 130. In either case, the concentrator 110 can be started and stopped based on the operation of the flare cap 134 without interrupting the operation of the flare 130.

If desired, the flare cap 134 may be opened to a partial amount during operation of the concentrator 110 to control the amount of gas that is transferred from the flare 130 to the concentrator 110. This operation, in conjunction with the operation of the ambient air valve, may be useful in controlling the temperature of the gas at the entrance of the venturi section 162.

FIG. 4 illustrates a schematic diagram of a control system 300 that may be used to operate the concentrator 110 of FIG. 2. As illustrated in FIG. 4, the control system 300 includes a controller 302, which may be a form of digital signal processor type of controller, a programmable logic controller (PLC) which may run, for example, ladder logic based control, or any other type of controller. The controller 302 is, of course, connected to various components within the concentrator 110. In particular, the controller 302 is connected to the flare cap drive motor 135, which controls the opening and closing operation of the flare cap 134. The motor 135 may be set up to control the flare cap 134 to move between a fully open and a fully closed position. However, if desired, the controller 302 may control the drive motor 135 to open the flare cap 134 to any of a set of various different controllable positions between the fully opened and the fully closed position. The motor 135 may be continuously variable if desired, so that the flare cap 134 may be positioned at any desired point between fully open and fully closed.

Additionally, the controller 302 is connected to and controls the ambient air inlet valve 306 disposed in the air pre-treatment assembly 119 of FIG. 2 upstream of the venturi section 162 and may be used to control the pumps 182 and 184 which control the amount of and the ratio of the injection of new liquid to be treated and the re-circulating liquid being treated within the concentrator 110. The controller 302 may be operatively connected to a sump level sensor 317 (e.g., a float sensor, a non-contact sensor such as a radar unit, or a differential pressure cell). The controller 302 may use a signal from the sump level sensor 317 to control the pumps 182 and 184 to maintain the level of concentrated fluid within the sump 172 at a predetermined or desired level. Also, the controller 302 may be connected to the induced draft fan 190 to control the operation of the fan 190, which may be a single speed fan, a variable speed fan or a continuously controllable speed fan. In one embodiment, the induced draft fan 190 is driven by a variable frequency motor, so that the frequency of the motor is changed to control the speed of the fan. Moreover, the controller 302 is connected to a temperature sensor 308 disposed at, for example, the inlet of the concentrator assembly 120 or at the inlet of the venturi section 162, and receives a temperature signal generated by the temperature sensor 308. The temperature sensor 308 may alternatively be located downstream of the venturi section 162 or the temperature sensor 308 may include a pressure sensor for generating a pressure signal.

During operation and at, for example, the initiation of the concentrator 110, when the flare 130 is actually running and is thus burning gas, the controller 302 may first turn on the induced draft fan 190 to create a negative pressure within the fluid scrubber 122 and the concentrator assembly 120. The controller 302 may then or at the same time, send a signal to the motor 135 to close the flare cap 134 either partially or completely, to direct waste heat from the flare 130 into the transfer pipe 140 and thus to the air pre-treatment assembly 119. Based on the temperature signal from the temperature sensor 308, the controller 302 may control the ambient air valve 306 (typically by closing this valve partially or completely) and/or the flare cap actuator to control the temperature of the gas at the inlet of the concentrator assembly 120. Generally speaking, the ambient air valve 306 may be biased in a fully open position (i.e., may be normally open) by a biasing element such as a spring, and the controller 302 may begin to close the valve 306 to control the amount of ambient air that is diverted into the air pre-treatment assembly 119 (due to the negative pressure in the air pre-treatment assembly 119), so as to cause the mixture of the ambient air and the hot gases from the flare 130 to reach a desired temperature. Additionally, if desired, the controller 302 may control the position of the flare cap 134 (anywhere from fully open to fully closed) and may control the speed of the induced draft fan 190, to control the amount of gas that enters the air pre-treatment assembly 119 from the flare 130. As will be understood, the amount of gas flowing through the concentrator 110 may need to vary depending on ambient air temperature and humidity, the temperature of the flare gas, the amount of gas exiting the flare 130, etc. The controller 302 may therefore control the temperature and the amount of gas flowing through the concentrator assembly 120 by controlling one or any combination of the ambient air control valve 306, the position of the flare cap 134 and the speed of the induced draft fan 190 based on, for example, the measurement of the temperature sensor 308 at the inlet of the concentrator assembly 120. This feedback system is desirable because, in many cases, the air coming out of a flare 130 is between 1200 and 1800 degrees Fahrenheit, which may be too hot, or hotter than required for the concentrator 110 to operate efficiently and effectively.

In any event, as illustrated in FIG. 4, the controller 302 may also be connected to a motor 310 which drives or controls the position of the venturi plate 163 within the narrowed portion of the concentrator assembly 120 to control the amount of turbulence caused within the concentrator assembly 120. Still further, the controller 302 may control the operation of the pumps 182 and 184 to control the rate at which (and the ratio at which) the pumps 182 and 184 provide re-circulating liquid and new waste fluid to be treated to the inputs of the quencher 159 and the venturi section 162. In one embodiment, the controller 302 may control the ratio of the re-circulating fluid to new fluid to be about 10:1, so that if the pump 184 is providing 8 gallons per minute of new liquid to the input 160, the re-circulating pump 182 is pumping 80 gallons per minute. Additionally, or alternatively, the controller 302 may control the flow of new liquid to be processed into the concentrator (via the pump 184) by maintaining a constant or predetermined level of concentrated liquid in the sump 172 using, for example, the level sensor 317. Of course, the amount of liquid in the sump 172 will be dependent on the rate of concentration in the concentrator, the rate at which concentrated liquid is pumped from or otherwise exists the sump 172 via the secondary re-circulating circuit and the rate at which liquid from the secondary re-circulating circuit is provided back to the sump 172, as well as the rate at which the pump 182 pumps liquid from the sump 172 for delivery to the concentrator via the primary re-circulating circuit.

If desired, one or both of the ambient air valve 306 and the flare cap 134 may be operated in a fail-safe open position, such that the flare cap 134 and the ambient air valve 306 open in the case of a failure of the system (e.g., a loss of control signal) or a shutdown of the concentrator 110. In one case, the flare cap motor 135 may be spring loaded or biased with a biasing element, such as a spring, to open the flare cap 134 or to allow the flare cap 134 to open upon loss of power to the motor 135. Alternatively, the biasing element may be the counter-weight on the flare cap 134 may be so positioned that the flare cap 134 itself swings to the open position under the applied force of the counter-weight 137 when the motor 135 loses power or loses a control signal. This operation causes the flare cap 134 to open quickly, either when power is lost or when the controller 302 opens the flare cap 134, to thereby allow hot gas within the flare 130 to exit out of the top of the flare 130. Of course, other manners of causing the flare cap 134 to open upon loss of control signal can be used, including the use of a torsion spring on the pivot point 136 of the flare cap 134, a hydraulic or pressurized air system that pressurizes a cylinder to close the flare cap 134, loss of which pressure causes the flare cap 134 to open upon loss of the control signal, etc.

Thus, as will be noted from the above discussion, the combination of the flare cap 134 and the ambient air valve 306 work in unison to protect the engineered material incorporated into the concentrator 110, as whenever the system is shut down, the flare cap and the air valve 306 automatically immediately open, thereby isolating hot gas generated in the flare 130 from the process while quickly admitting ambient air to cool the process.

Moreover, in the same manner, the ambient air valve 306 may be spring biased or otherwise configured to open upon shut down of the concentrator 110 or loss of signal to the valve 306. This operation causes quick cooling of the air pre-treatment assembly 119 and the concentrator assembly 120 when the flare cap 134 opens. Moreover, because of the quick opening nature of the ambient air valve 306 and the flare cap 134, the controller 302 can quickly shut down the concentrator 110 without having to turn off or effect the operation of the flare 130.

Furthermore, as illustrated in the FIG. 4, the controller 302 may be connected to the venturi plate motor 310 or other actuator which moves or actuates the angle at which the venturi plate 163 is disposed within the venturi section 162. Using the motor 310, the controller 302 may change the angle of the venturi plate 163 to alter the gas flow through the concentrator assembly 120, thereby changing the nature of the turbulent flow of the gas through concentrator assembly 120, which may provide for better mixing of the and liquid and gas therein and obtain better or more complete evaporation of the liquid. In this case, the controller 302 may operate the speed of the pumps 182 and 184 in conjunction with the operation of the venturi plate 163 to provide for optimal concentration of the wastewater being treated. Thus, as will be understood, the controller 302 may coordinate the position of the venturi plate 163 with the operation of the flare cap 134, the position of the ambient air or bleed valve 306, and the speed of the induction fan 190 to maximize wastewater concentration (turbulent mixing) without fully drying the wastewater so as to prevent formation of dry particulates. The controller 302 may use pressure inputs from the pressure sensors to position the venturi plate 163. Of course, the venturi plate 163 may be manually controlled or automatically controlled.

The controller 302 may also be connected to a motor 312 which controls the operation of the damper 198 in the gas re-circulating circuit of the fluid scrubber 122. The controller 302 may cause the motor 312 or other type of actuator to move the damper 198 from a closed position to an open or to a partially open position based on, for example, signals from pressure sensors 313, 315 disposed at the gas entrance and the gas exit of the fluid scrubber 122. The controller 302 may control the damper 198 to force gas from the high pressure side of the exhaust section 124 (downstream of the induced draft fan 190) into the fluid scrubber entrance to maintain a predetermined minimum pressure difference between the two pressure sensors 313. 315. Maintaining this minimum pressure difference assures proper operation of the fluid scrubber 122. Of course, the damper 198 may be manually controlled instead or in addition to being electrically controlled.

Thus, as will be understood from the above discussion, the controller 302 may implement one or more on/off control loops used to start up or shut down the concentrator 110 without affecting the operation of the flare 130. For example, the controller 302 may implement a flare cap control loop which opens or closes the flare cap 134, a bleed valve control loop which opens or begins to close the ambient air valve 306, and an induced draft fan control loop which starts or stops the induced draft fan 190 based on whether the concentrator 110 is being started or stopped. Moreover, during operation, the controller 302 may implement one or more on-line control loops which may control various elements of the concentrator 110 individually or in conjunction with one another to provide for better or optimal concentration. When implementing these on-line control loops, the controller 302 may control the speed of induced draft fan 190, the position or angle of the venturi plate 163, the position of the flare cap 134 and or the position of the ambient air valve 306 to control the fluid flow through the concentrator 110, and/or the temperature of the air at the inlet of the concentrator assembly 120 based on signals from the temperature and pressure sensors. Moreover, the controller 302 may maintain the performance of the concentration process at steady-state conditions by controlling the pumps 184 and 182 which pump new and re-circulating fluid to be concentrated into the concentrator assembly 120. Still further, the controller 302 may implement a pressure control loop to control the position of the damper 198 to assure proper operation of the fluid scrubber 122. Of course, while the controller 302 is illustrated in FIG. 4 as a single controller device that implements these various control loops, the controller 302 could be implemented as multiple different control devices by, for example, using multiple different PLCs.

The concentrator 110 of FIGS. 2-4 directly utilizes hot gases in processes after the gases have been thoroughly treated to meet emission standards, and so seamlessly separates the operational requirements of the process that generates the waste heat from the process which utilizes the waste heat in a simple, reliable and effective manner.

While the liquid concentrator 110 has been described above as being connected to a flare to use the hot gases generated in the flare, the liquid concentrator 110 can be connected to other sources of hot gas, or to ambient air.

In some instances, the supply of heated gas (such as from a flare or exhaust gas from a power plant) may be limited. In these cases, it may be beneficial to perform a first stage evaporation without heated gas to reduce the overall amount of water in the wastewater, which reduces the need for high temperature (high energy) gas in the second stage concentrator. In other instances, the low temperature gas concentrator may be used as a stand-alone evaporation device.

Some cases where high temperature gas may be limited include when concentrating flue gas desulfurization water from power plants, when concentrating evaporation pond water, or when concentrating landfill leachate. However, in this case, there may be lower temperature gas available to aid in the concentration process. For example, many power plants have a large quantity of low temperature steam (which is the residual gas from an electric turbine) that is normally condensed. While this low temperature steam is not very energy rich in sensible heat it is energy rich in latent heat and the energy in the steam can be used to concentrate the flue gas desulfurization water in a first stage of a two-stage concentration process, or in a stand-alone one stage concentration process. In some embodiments, the concentrator described above, with respect to FIGS. 1-4 may be used as the second stage concentrator and, with some modifications, as the first stage concentrator.

Turning now to FIG. 5, one embodiment of a two-stage concentration system 1000 is illustrated. The two-stage concentration system 1000 may include a first stage concentrator 1110 and a second stage concentrator 1210. In the system illustrated in FIG. 5, the second stage concentrator 1210 may be formed in accordance with the concentrators 10, 110 described above with respect to FIGS. 2-4. For the sake of brevity, the details of the second stage concentrator 1210 will not be discussed further. In other embodiments, the second stage concentrator 1210 may take the form of a submerged gas evaporator having a downcomer and a weir, which may be referred to as a continuous liquid phase—discontinuous gas phase concentrator.

The first stage concentrator 1110 may be very similar to the concentrators 10, 110 described above, but with modifications to utilize low energy gas, such as low pressure steam from a power plant. In other embodiments, the first stage concentrator 1110 may take the form of a submerged gas evaporator having a downcomer and a weir, which may be referred to as a continuous liquid phase—discontinuous gas phase concentrator.

Generally speaking, the first stage concentrator 1110 has a first stage evaporation section 1120 having a wastewater input 1160, an ambient air input 1161, and an exhaust 1124 to vent exhaust gas to the atmosphere. Partially concentrated wastewater (in the form of partially concentrated flue gas desulfurization water in the example of FIG. 5) may be removed from the first stage evaporation section 1120 (for example, by being pumped out of a sump) and sent to a heat exchanger 1190. The heat exchanger 1190 includes a low temperature steam input 1192 and a condensate output 1194 that returns condensate to a boiler feed water system (not shown). A source of low temperature steam 1196, such as low temperature steam from a power plant turbine, is connected to the low temperature steam input 1192. Low temperature steam from the source of low temperature steam 1196 heats the partially concentrated wastewater in the heat exchanger 1190, thereby providing some energy to drive evaporation of the wastewater in the first stage evaporation section 1120 without using a high temperature gas input. Rather, the heating of the partially concentrated wastewater in the heat exchanger allows the first stage concentrator 1110 to use ambient air as the gas source. As a result, the first stage concentrator 1110 significantly reduces the water component of the wastewater without using hot gases. In some cases, the first stage concentrator 1110 allows the second stage concentrator 1210 to be reduced in size by 25%-50% over the size that would otherwise be needed without the first stage concentrator 1110. In other cases, the first stage concentrator 1110 could be used as a stand-alone low temperature steam concentrator when the energy provided by the low temperature steam is sufficient to drive adequate evaporation for a particular use, or the first stage concentrator 1110 could be used as a stand-alone two stage batch processing concentrator in which a first stage evaporation is provided by the low temperature steam operation, where the concentrated wastewater is held in a holding tank, and a second stage evaporation is provided by switching the first stage concentrator 1110 to a heated gas operation (similar to the operations described in FIGS. 1-4) and the concentrated wastewater is withdrawn from the holding tank and cycled through the first stage concentrator 1110 a second time utilizing heated gas to perform a second stage evaporation.

Because the heat from the low temperature steam is transferred to the wastewater through the heat exchanger 1190, and evaporation is accomplished in a separate vessel, fouling and scaling in the heat exchanger 1190 is substantially reduced. Additionally, the low temperature steam 1196 may have a very low pressure or even a negative pressure (e.g., less than 0 psig). In the case of power plant wastewaters, calcium sulfate begins to precipitate at very dilute concentrations. The initial precipitation of calcium sulfate may be kept suspended by the circulation of the wastewater in the first stage concentrator 1110. The suspended calcium sulfate can act as a “seed” location for further calcium sulfate precipitation in the first stage concentrator 1110, which reduces the amount of calcium sulfate that agglomerate on other surfaces in the system. Additionally, chemical dispersants may be added to the partially concentrated wastewater to further reduce agglomeration of calcium sulfate on concentrator surfaces.

Some of the partially concentrated wastewater is drawn off from the first stage evaporation section 1120 thorough a partially concentrated wastewater exit and sent to a holding tank (not shown, but located between the first stage evaporation section 1120 and a second stage evaporation section 1220), which would further direct the partially concentrated wastewater to a liquid inlet 1260 of the second stage evaporation section 1220 of the second stage concentrator 1210. Hot gas is supplied to the second stage evaporation section 1220 and evaporation occurs as described above with respect to FIGS. 1-4. A solid/liquid separator 1222, such as a cross-flow scrubber, removes entrained liquid droplets from the second stage evaporation section 1220 and a solid portion of the removed entrained liquid droplets is removed for disposal, also as described above with respect to FIGS. 1-4. As discussed above, the first stage concentrator 1110 and the second stage evaporator 1210 could be combined in a single evaporator that is operated on a batch processing basis that evaporates the liquid wastewater in a first stage utilizing low temperature steam and in a second stage utilizing heated gas.

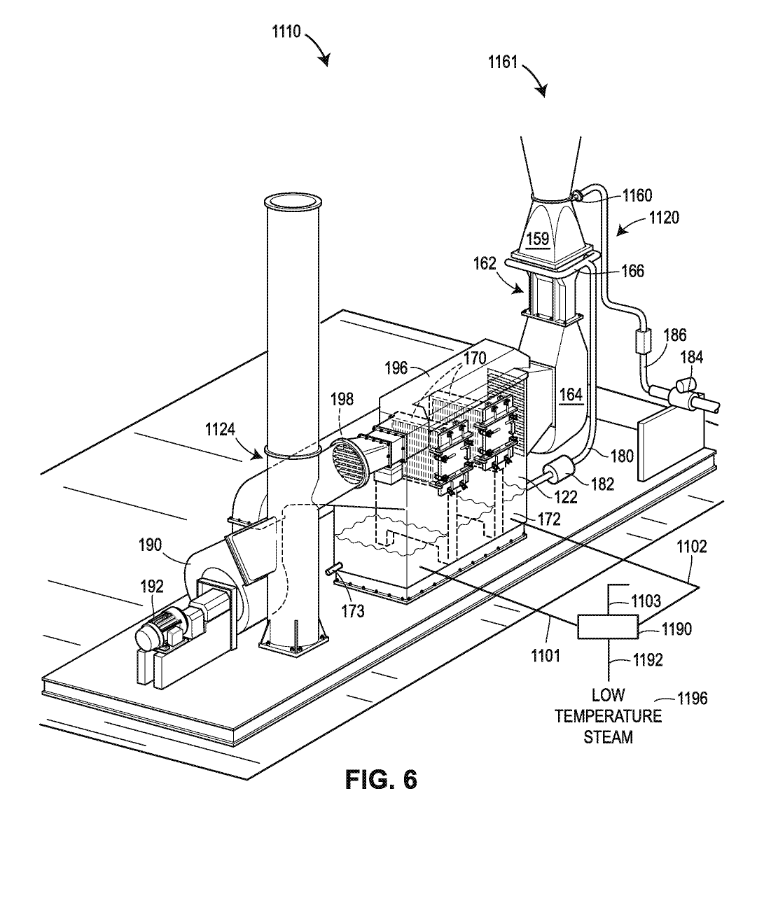

Turning now to FIG. 6, one embodiment of a modified concentrator 1110 that may be used as the first stage concentrator 1110 from FIG. 5 is illustrated. The elements of the embodiment of FIG. 6 that correspond to the elements of the embodiment 110 of FIG. 3 have identical reference numbers and will not be further discussed here. If an understanding of a common element is desired, the reader is directed to the discussion of FIGS. 1-4 above. The modified concentrator 1110 may include a partially concentrated wastewater extraction line 1101 is fluidly connected to the sump 172 at one end and fluidly connected to a heat exchanger 1190 at another end. A heated partially concentrated wastewater return line 1102 is fluidly connected to the heat exchanger 1190 at one end and to the sump 172 at another end. Partially concentrated wastewater is drawn from the sump 172, through the partially concentrated wastewater extraction line 1101 by a pump (not shown in FIG. 6) and delivered to the heat exchanger 1190. Upon exit from the heat exchanger, the heated partially concentrated wastewater is returned to the sump 172 through the return line 1102. A low temperature steam inlet 1192 is fluidly connected to the heat exchanger 1190 at one end and to a source of low temperature steam 1196 at another end. Low temperature steam from the source of low temperature steam 1196 is delivered to the heat exchanger 1190 by a pump (not shown in FIG. 6) or other gas moving device through a low pressure steam input line 1192. Alternatively, low temperature steam from the source of low temperature steam 1196 may be drawn through the low temperature steam input line 1192 by a pressure differential that may be created by virtually any means understood in the art. The heat exchanger 1190 may take the form of any heat exchanger known in the art. For example the heat exchanger 1190 may take the form of a plate and frame heat exchanger or a shell and tube heat exchanger, an example of which is illustrated in FIG. 6.

The source of low temperature steam 1196 may include a source of ultra low temperature steam from a power plant. For example, the source of low temperature steam 1196 may include steam having a pressure from about −13 psig to about 40 psi. Steam in this range of pressures has a relatively low temperature. Steam in this range of pressures generally has not been used in concentration processes because the sensible energy in such low temperature steam was thought to be too low to be economically useful. The inventors of the instant application have discovered that this low temperature (energy lean) steam is useful in the concentrator described herein to heat the partially concentrated wastewater. After heating in the heat exchanger 1190, the heated partially concentrated wastewater is returned to the sump 172, where it raises the overall temperature of the partially concentrated wastewater in the sump 172 by, for example, between 120 degrees and 180 degrees. By drawing the partially concentrated wastewater from the sump 172, through the heat exchanger 1190, and back to the sump 172, high flow rates may be maintained through the heat exchanger 1190 and moderate increases in temperature may be realized in the sump without fouling the heat exchanger and/or while maximizing efficiency of heat transfer from the low temperature steam to the partially concentrated wastewater. In an alternate embodiment, a separate recirculating loop may recirculate concentrated wastewater in a separate circuit, through the heat exchanger 1190. Such a separate recirculating loop allows the heat exchanger 1190 to be reduced in size and allows the concentrated wastewater to remain in a turbulent state, which produces better heat exchange while reducing fouling risk.

The moderately heated partially concentrated wastewater in the sump 172 will have enough energy latent in the liquid to enhance evaporation in the first stage evaporation section 1120 without using heated gas. As a result, ambient air may be used for the gas steam in the first stage evaporation section 1120.

Typically, the percentage of water in the wastewater steam may be reduced by 20% to 90% during in the first stage concentrator 1110. As a result, the second stage concentrator 1210 may be reduced in size by between 25% and 50% below what would be needed to affect a comparable evaporation in a single stage hot gas concentrator. The net result is a decrease in high temperature energy that is required for the two-stage concentration system 1000 over a single stage concentration system. In other embodiments, the second stage concentrator may be eliminated if the latent heat in the low temperature steam is sufficient to produce adequate evaporation for an intended use.

While the first stage concentrator 1110 has been described above as part of a two-stage concentration system 1000, the first stage concentrator 1110 may also be used as a stand-alone concentrator when moderate levels of concentration are needed and/or when only moderate levels of volume reduction of the wastewater are required. For example, moderate levels of volume reduction may include 20%-90% of volume reduction.

While the first stage concentrator 1110 has been illustrated as a discontinuous liquid phase—continuous gas phase concentrator, in other embodiments, a continuous liquid phase—discontinuous gas phase concentrator, such as a concentrator having a downcomer and a weir in a liquid containing vessel, may be used.

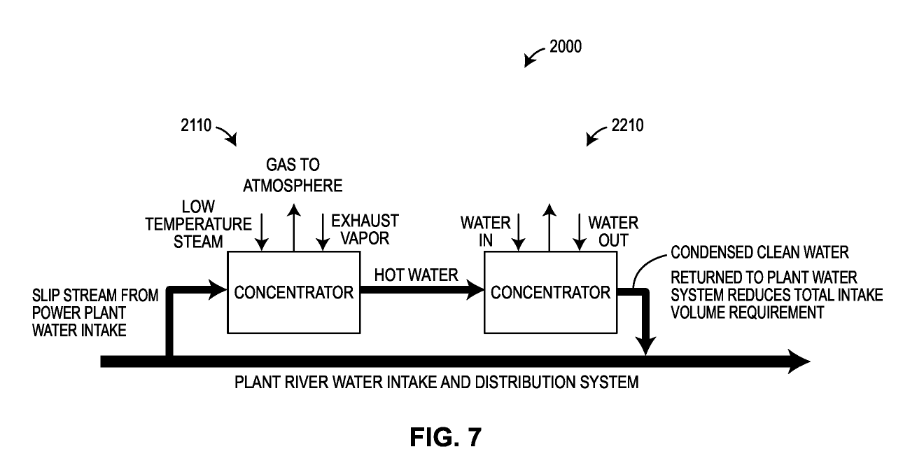

Turning now to FIG. 7, an alternate embodiment of a two-stage concentration system 2000 is illustrated. In the embodiment of FIG. 7, the two-stage concentration system 2000 may include a first concentrator 2110 and a second concentrator 2210. The first and second concentrators may take the form of the discontinuous liquid phase—continuous gas phase concentrators described above, or one or more of the first and second concentrators may take the form of a continuous liquid phase—discontinuous gas phase concentrator, such as a concentrator having a downcomer and a weir.

The first stage concentrator may remove some level of a slipstream water from a main water intake to a power plant and process it through in a combination water heater / clean water recovery unit (first stage concentrator 2110). The first stage concentrator may be driven by low temperature steam from condensing turbines combined with vapor exhaust from the second stage concentrator 2210. The vapor exhaust from the second stage concentrator provides non-condensable gas that prevents the first stage concentrator 2110 from experiencing cavitation. Further, because the vapor exhaust from the second stage concentrator 2210 approaches the adiabatic saturation temperature, the non-condensable portion of this vapor exhaust is saturated and, therefore, not capable of producing an evaporative cooling effect within the first stage evaporator 2110.

This arrangement produces a compact, extremely simple, durable and reliable unit that performs both functions without need for conventional heat exchangers other than that for heat transfer from the hot water produced in the first stage concentrator 2110 to the second stage concentrator 2110 concentrator hot water feed. Advantages include inexpensive highly corrosion resistant construction with self-cleaning action based on turbulence.

By selecting a ratio of plant water intake slipstream volume to combined concentrator exhaust gas and condensing steam mass significant quantities of clean hot water feed for the stage concentrator 2210 may be produced while recovering a significant portion of thermal energy used to evaporate purge water the concentrator and while condensing, capturing and reusing low temperature turbine steam as hot water that is directly returned to the power plant water distribution system after supplying heat for the second stage concentrator 2210. As a result, the water may be reused for boiler water makeup etc. within the power plant.

Additionally, this process reduces river water intake volume via recycle, which is an environmentally sound feature.

While certain representative embodiments and details have been shown for purposes of illustrating the invention, it will be apparent to those skilled in the art that various changes in the methods and apparatus disclosed herein may be made without departing from the scope of the invention.

1. A liquid concentrator, comprising:
a concentrator section including;
a gas inlet,
a gas outlet,
a mixing corridor disposed between the gas inlet and the gas outlet, the mixing corridor having a narrowed portion in which gas flow within the mixing corridor accelerates when traveling from the gas inlet to the gas outlet; and
a liquid inlet through which liquid to be concentrated is injected into the mixing corridor, the liquid inlet disposed in the mixing corridor between the gas inlet and the narrowed portion;
a demister disposed downstream of the concentrator section, the demister including;
a demister gas flow passage coupled to the gas outlet of the concentrator section,
a liquid collector disposed in the demister gas flow passage to remove liquid from gas flowing in the demister gas flow passage, and
a reservoir that collects the liquid removed from the gas flowing in the demister gas flow passage by the liquid collector; and
a heat exchanger fluidly connected to the reservoir, the heat exchanger being fluidly coupled to a source of low temperature gas.

2. The liquid concentrator of claim 1, wherein the source of low temperature gas is a source of low temperature steam from a power plant.

3. The liquid concentrator of claim 2, wherein the low temperature steam has a pressure of between −7 psig and 40 psi.

4. The liquid concentrator of claim 1, further including a re-circulating circuit disposed between reservoir and the mixing corridor to transport liquid within the reservoir to the mixing corridor.

5. The liquid concentrator of claim 4, wherein the re-circulating circuit is coupled to the liquid inlet of the concentrator section.

6. The liquid concentrator of claim 4, wherein the concentrator section includes a further liquid inlet disposed in the mixing corridor between the gas inlet and the narrowed portion, the further liquid inlet being coupled to the re-circulating circuit to inject liquid from the reservoir into the mixing corridor for further concentrating.

7. The liquid concentrator of claim 6, wherein the further liquid inlet is disposed in the mixing corridor downstream of the liquid inlet.

8. The liquid concentrator of claim 6, wherein the further fluid inlet includes multiple fluid entrances, with a separate fluid entrance disposed in each of two or more side walls of the mixing corridor, and wherein the re-circulating circuit includes a pipe that partially surrounds the mixing corridor to provide concentrated liquid to each of the multiple fluid entrances.

9. The liquid concentrator of claim 1, wherein the concentrator section includes an adjustable flow restriction disposed in the narrowed portion of the mixing corridor, the flow restriction adjustable to alter gas flow through the mixing corridor.

10. The liquid concentrator of claim 9, wherein the adjustable flow restriction is a venturi plate that is adjustable to change the size or shape of the narrowed portion of the mixing corridor.

11. The liquid concentrator of claim 1, further comprising a concentrated liquid extraction port in the reservoir.

12. The liquid concentrator of claim 1, further comprising an induction fan located downstream of the demister to provide a negative pressure gradient through the demister.

13. The liquid concentrator of claim 12, wherein the induction fan is connected to a variable frequency drive motor that operates to vary the speed of the induction fan to create varying levels of negative pressure gradients through the demister.

14. The liquid concentrator of claim 12, wherein the induction fan disposed downstream of the demister and wherein the demister includes a demister gas inlet and a gas re-circulating circuit connected between a point downstream of the induction fan and the demister gas inlet to divert a portion of gas from the point downstream of the induction fan to the demister gas inlet.

15. The liquid concentrator of claim 1, wherein the gas inlet of the concentrator section is fluidly connected to a source of ambient air.

16. The liquid concentrator of claim 1, further comprising a condensate extraction port connected to the heat exchanger.

17. The liquid concentrator of claim 1, further comprising a partially concentrated wastewater exit that is fluidly connected to a liquid inlet of a second stage evaporation section of a second stage concentrator.

18. The liquid concentrator of claim 17, wherein the second stage concentrator includes a hot gas inlet.

19. The liquid concentrator of claim 1, wherein the mixing corridor includes a downcomer, and an annular space between the downcomer and a weir in a fluid vessel.
